(19) United States
(12) Patent Application Publication
(10) Pub. No.: US 2021/0276267 A1
(43) Pub. Date: Sep. 9, 2021

(54) METHODS FOR ADDITIVE MANUFACTURING A THREE-DIMENSIONAL ARTICLE

(71) Applicant: TOYOTA RESEARCH INSTITUTE, INC., LOS ALTOS, CA (US)

(72) Inventor: Abraham Anapolsky, San Mateo, CA (US)

(73) Assignee: TOYOTA RESEARCH INSTITUTE, INC., LOS ALTOS, CA (US)

(21) Appl. No.: 16/810,085

(22) Filed: Mar. 5, 2020

(51) Int. Cl. B29C 64/393; B33Y 10/00; B33Y 30/00; B33Y 50/02

(52) U.S. Cl. CPC B29C 64/393; B33Y 50/02; B33Y 30/00; B33Y 10/00

(57) ABSTRACT

A method for additive manufacturing a three-dimensional article may comprise simulating the three-dimensional article based on at least one parameter characterizing the three-dimensional article such that the three-dimensional article comprises a first region comprising a first base material and a second region comprising a second base material. The method may further comprise generating a set of print instructions based on a conformation of the three-dimensional article, preparing an additive manufacturing feedstock comprising the first base material and the second base material based on the three-dimensional article, and supplying the set of print instructions and the additive manufacturing feedstock to an additive manufacturing device. The additive manufacturing device may then fabricate the three-dimensional article using the additive manufacturing feedstock based on the set of print instructions.

### TECHNICAL FIELD

The present specification generally relates to additive manufacturing processes for the production of three-dimensional articles and, more specifically, the augmentation of the base materials of an additive manufacturing process relative to the design-optimized constraints of the three-dimensional article.

### BACKGROUND

Additive manufacturing technologies use computer designs, such as computer-aided design (CAD) files, to generate three-dimensional articles. The additive manufacturing, commonly referred to as “3D printing,” of a three-dimensional article conventionally comprises the deposition, fusion, or formation of a feedstock material into sequential cross-sectional layers of the three-dimensional article. Three-dimensional articles fabricated by additive manufacturing may be structurally optimized to enhance performance by departing from the simple geometric designs that can be economically produced through conventional manufacturing techniques, such as casting and subtractive machining.

However, the structural optimization of three-dimensional articles fabricated by additive manufacturing may be necessarily constrained. For example, when fabricating a three-dimensional article for a particular use, such as a turbine blade for use in a turbine engine, the physical parameters of the three-dimensional article may be limited. That is, the weight, the density, or the dimensions of the three-dimensional article may have particular upper and lower bounds that must be accounted for. As a result, the properties of the three-dimensional article may also be limited. For example, the tensile strength of a three-dimensional article may be typically increased by increasing the thickness of portions of the three-dimensional article. However, if the thickness of the three-dimensional article is constrained by the intended use, the achievable tensile strength will also be limited.

Accordingly, a need exists for alternative methods for additive manufacturing three-dimensional articles. In particular, a need exists for alternative methods for additive manufacturing three-dimensional articles that allow for the further optimization of three-dimensional articles within the design-optimized constraints imposed by the structure of the three-dimensional article. The systems and methods of the present disclosure may further optimize additive manufacturing processes and the resulting three-dimensional articles by augmenting the base materials such that the three-dimensional article is composed of two, three, four, or more base materials as opposed to just one. This may allow for the improvement or optimization of additional parameters, such as tensile strength, within the design-optimized constraints of the structure of the three-dimensional article and the intended application.

### SUMMARY

In one embodiment, a method for additive manufacturing a three-dimensional article may comprise simulating the three-dimensional article based on at least one parameter characterizing the three-dimensional article such that the three-dimensional article comprises a first region comprising a first base material and a second region comprising a second base material. The method may further comprise generating a set of print instructions based on a conformation of the three-dimensional article, preparing an additive manufacturing feedstock comprising the first base material and the second base material based on the three-dimensional article, and supplying the set of print instructions and the additive manufacturing feedstock to an additive manufacturing device. The additive manufacturing device may then fabricate the three-dimensional article using the additive manufacturing feedstock based on the set of print instructions.

In another embodiment, a system for additive manufacturing a three-dimensional article may comprise a controller configured to simulate the three-dimensional article based on at least one parameter characterizing the three-dimensional article such that the three-dimensional article comprises a first region comprising a first base material and a second region comprising a second base material, generate a set of print instructions based on a conformation of the three-dimensional article, and generate an additive manufacturing feedstock comprising the first base material and the second base material based on the three-dimensional article. The system may also comprise an additive manufacturing device operable to fabricate the three-dimensional article using the additive manufacturing feedstock based on the set of print instruction.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an illustrative system for additive manufacturing a three-dimensional article, according to one or more embodiments shown and described herein;

FIG. 2 depicts another illustrative system having an electronic controller for additive manufacturing a three-dimensional article, according to one or more embodiments shown and described herein;

FIG. 3 depicts a flow diagram of an illustrative method for additive manufacturing a three-dimensional article, according to one or more embodiments shown and described herein;

FIG. 4 depicts a three-dimensional article comprising a first region comprising a first base material and a second region comprising a second base material, according to one or more embodiments shown and described herein; and

FIG. 5 depicts the preparation of an additive manufacturing feedstock comprising a first base material and a second base material, according to one or more embodiments shown and described herein.

### DETAILED DESCRIPTION

The present disclosure relates generally to additive manufacturing and, in particular, the augmentation of the base materials of an additive manufacturing process relative to the design-optimized constraints of the three-dimensional article. Put more simply, the present disclosure relates to optimizing the base materials of a three-dimensional article in a co-dependent manner with the design-optimized structure of the three-dimensional article. A three-dimensional article may be structurally optimized based on the desired application. That is, the height, width, wall thickness, etc. of the three-dimensional article is determined and optimized with regard to the intended end use. However, this structural optimization does not necessarily result in the optimization of all relevant parameters of the three-dimensional article. For example, the intended application of the three-dimensional article may limit the maximum wall thickness of the structure and, as a result, limit the achievable tensile strength of the three-dimensional article. This is further compounded by the fact that conventional additive manufacturing processes utilize a single material to fabricate the monolithic structures. As a result, parameters such as tensile strength may be necessarily limited in order to meet structural requirements. The systems and methods of the present disclosure may further optimize additive manufacturing processes and the resulting three-dimensional articles by augmenting the base materials such that the three-dimensional article is composed of two, three, four, or more base materials as opposed to just one. This may allow for the improvement or optimization of additional parameters, such as tensile strength, within the design-optimized constraints of the structure of the three-dimensional article and the intended application.

Embodiments disclosed herein relate to methods for additive manufacturing three-dimensional articles. More specifically, the present disclosure describes methods that optimize the three-dimensional structure via the augmentation of the base materials of the additive manufacturing process relative to the design-optimized constraints of the three-dimensional article. For example, embodiments disclosed herein may include a method for additive manufacturing a three-dimensional article comprising optimizing the three-dimensional article based on at least one parameter characterizing the three-dimensional article. Such optimizing may comprise designing the three-dimensional article such that the three-dimensional article comprises a first region comprising a first material and a second region comprising a second material. The method may further comprise generating a set of print instructions based on a conformation of the three-dimensional article and one or more deconstruction parameters, preparing an additive manufacturing feedstock corresponding to the set of print instructions and comprising the first material and the second material, and supplying the set of print instructions and the additive manufacturing feedstock to an additive manufacturing device. The additive manufacturing device may then fabricate the three-dimensional article using the additive manufacturing feedstock based on the set of print instructions.

The following will now describe these systems and methods in more detail with reference to the drawings and where like numbers refer to like structures.

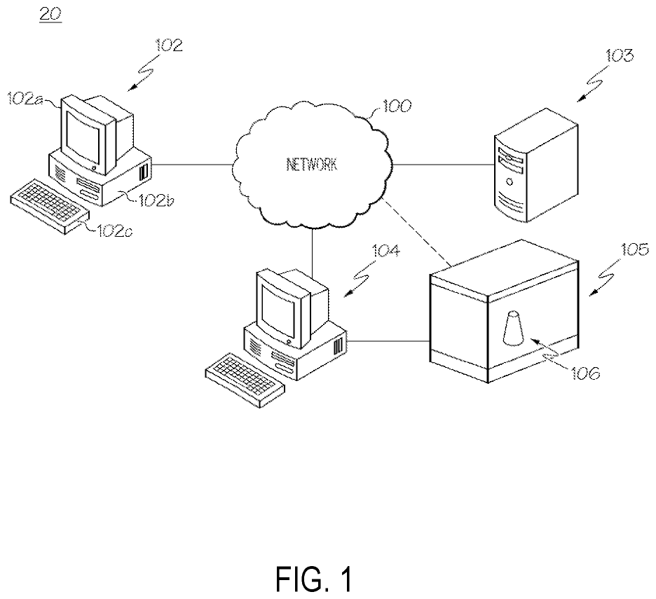

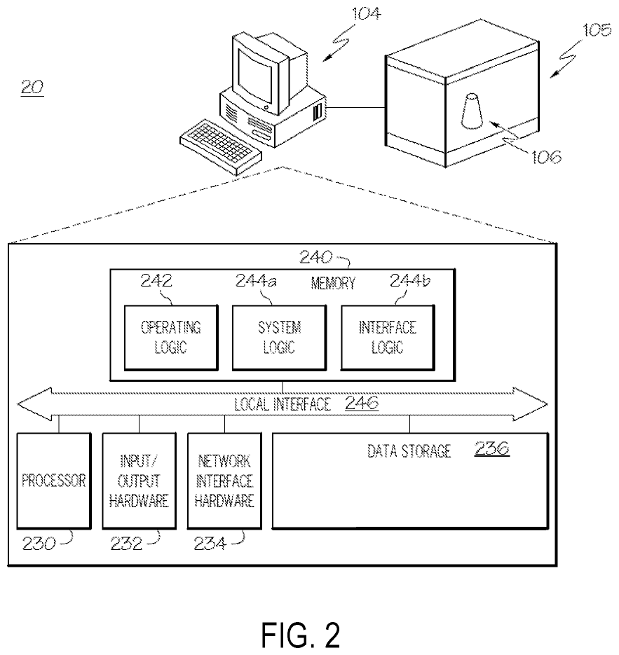

Referring to FIGS. 1 and 2, illustrative systems and computing devices configured to additive manufacture an optimized three-dimensional article are depicted. In other words, FIGS. 1 and 2 depict a system 20 for additive manufacturing an optimized three-dimensional article. In particular, FIG. 1 depicts one example system implemented over a network of devices to optimize and fabricate a three-dimensional article. The system of FIG. 1 may be implemented over a network 100. The network 100 may include a wide area network, such as the internet, a local area network (LAN), a mobile communications network, a public service telephone network (PSTN) and/or other network. The network 100 may be configured to electronically and/or communicatively connect a user computing device 102, one or more data servers 103 optionally storing one or more databases having optimized three-dimensional models and/or print instructions, and an electronic controller 104. An additive manufacturing device 105 for fabricating an optimized three-dimensional article 106 is included in the system and is communicatively coupled to the network 100 and/or the electronic controller 104.

The user computing device 102 may include a display 102a, a processing unit 102b, and an input device 102c, each of which may be communicatively coupled together and/or to the network 100. The user computing device 102 may be a server, a personal computer, a laptop, a tablet, a smartphone, a handheld device, or the like. The user computing device 102 may be used by a user of the system to provide information to the system. For example, the user may utilize the user computing device and, for example, one more computer programs implemented on the user computing device 102 to optimize a three-dimensional article, as described in further detail herein. The user computing device 102 may utilize a local application or a web application to access the system enabled by the electronic controller 104 as described herein. The electronic controller 104 may host and provide an interactive interface to the user computing device 102 such that a user may query, select, and/or input information that may be relayed to the electronic controller 104. The system may also include one or more data servers 103 having one or more databases from which information may be queried, extracted, updated, and/or utilized by the electronic controller 104.

Additionally, the system includes an electronic controller 104. The electronic controller 104 may be a server, a personal computer, a laptop, a tablet, a smartphone, an application specification handheld device, or the like. The electronic controller 104 may include a display and an input device each of which may be communicatively coupled together. The electronic controller 104, which is described in more detail herein, may be configured to host applications and execute processes related to the system described herein. It should be understood that while a user computing device 102 and one or more data servers 103 are depicted in the illustrative system of FIG. 1, each of the functions and operations performed by the user computing device 102 and one or more data servers 103 may be embodied and configured by the electronic controller 104.

It is also understood that while the user computing device 102 and the electronic controller 104 are depicted as personal computers and the one or more data servers 103 is depicted as a server, these are merely examples. More specifically, in some embodiments, any type of computing device (e.g., mobile computing device, personal computer, server, and the like) may be utilized for any of these components. Additionally, while each of these computing devices is illustrated in FIG. 1 as a single piece of hardware, this is also an example. More specifically, each of the user computing device 102, the one or more data servers 103, and the electronic controller 104 may represent a plurality of computers, servers, databases, and the like. For example, each of the user computing device 102, the one or more data servers 103, and the electronic controller 104 may form a distributed or grid-computing framework for implementing the methods described herein.

The additive manufacturing device 105 may be any rapid-prototyping, rapid manufacturing device, or additive manufacturing device such as fused deposition modeling (FDM), stereolithography (SLA), digital light processing (DLP), selective laser sintering (SLS), selective laser melting (SLM), laminated object manufacturing (LOM), electron beam melting (EBM), and/or the like. The additive manufacturing device 105 may include a processor and memory and other electronic components for receiving a three-dimensional model of an optimized three-dimensional article 106 for fabricating. The three-dimensional model is a design configuration file corresponding to the three-dimensional article for fabricating that may be uploaded to the additive manufacturing device 105.

In some embodiments, the system may be implemented through the interconnectivity of multiple devices, as depicted in FIG. 1. In other embodiments, the system is implemented through an electronic controller 104 communicatively coupled to the additive manufacturing device 105. Regardless of the implementation of the system, FIG. 2 depicts an illustrative electronic controller 104. The electronic controller 104 may utilize hardware, software, and/or firmware, according to embodiments shown and described herein. While in some embodiments, the electronic controller 104 may be configured as a general-purpose computer with the requisite hardware, software, and/or firmware, in some embodiments, the electronic controller 104 may be configured as a special purpose computer designed specifically for performing the functionality described herein.

As illustrated in FIG. 2, the electronic controller 104 includes a processor 230, input/output hardware 232, network interface hardware 234, a data storage component 236, which may store information such as optimized three-dimensional models and/or print instructions, and a memory component 240. The processor 230 of the electronic controller 104 may be communicatively coupled to the memory component 240. As used herein, the term “communicatively coupled” generally refers to any link in a manner that facilitates communications. As such, “communicatively coupled” includes both wireless and wired communications, including those wireless and wired communications now known or later developed. The memory component 240 may generally comprise any non-transitory memory device capable of storing machine-readable instructions such that the machine-readable instructions can be accessed and executed by the processor. For example, the memory component 240 may comprise random-access memory (RAM), read-only memory (ROM), flash memory, or hard drives. While the computing device may be described herein with respect to a single memory component 240, it should be understood that embodiments may include more than one memory component 240. Additionally, the memory component 240 may be configured to store operating logic 242, system logic 244a for implementing one or more of the methods described herein, and interface logic 244b for implementing one or more interfaces (each of which may be embodied as a computer program, firmware, or hardware, as an example). A local interface 246 is also included in FIG. 2 and may be implemented as a bus or other interface to facilitate communication among the components of the electronic controller 104.

The processor 230 may include any processing component(s) configured to receive and execute programming instructions (such as from the data storage component 236 and/or the memory component 240). The instructions may be in the form of a machine readable instruction set stored in the data storage component 236 and/or the memory component 240. The machine-readable instructions may comprise logic or algorithm(s) written in any programming language of any generation (e.g., a first-generation programming language (1GL), a second-generation programming language (2GL), a third-generation programming language (3GL), a fourth-generation programming language (4GL), or a fifth-generation programming language (5GL)), such as, for example, machine language that may be directly executed by the processor, or assembly language, object-oriented programming (OOP), scripting languages, or microcode, that may be compiled or assembled into machine readable instructions and stored in the non-transitory processor readable memory modules. Alternatively, the machine-readable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. The input/output hardware 232 may include a monitor, keyboard, mouse, printer, camera, microphone, speaker, and/or other device for receiving, sending, and/or presenting data. The network interface hardware 234 may include any wired or wireless networking hardware, such as a modem, LAN port, Wi-Fi card, WiMax card, mobile communications hardware, and/or other hardware for communicating with other networks and/or devices. It should be understood that the data storage component 236 may reside local to and/or remote from the electronic controller 104 and may be configured to store one or more pieces of data for access by the electronic controller 104 and/or other components.

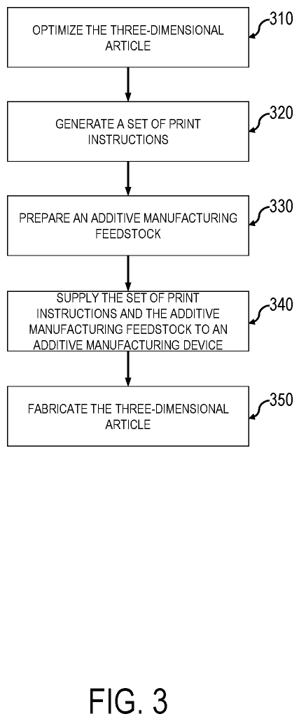

Methods implemented by the electronic controller 104 will now be described in more detail with respect to the flow diagram depicted in FIG. 3. FIG. 3 depicts a flow diagram of a method for additive manufacturing a three-dimensional article. The method depicted in the flow diagram may be implemented by the electronic controller (e.g., the electronic controller 104, depicted in FIGS. 1 and 2) and/or other components of the system described herein. However, for purposes of description and simplification the method will be described with reference only to the electronic controller 104. At block 310, the three-dimensional article may be simulated and optimized based on at least one parameter characterizing the three-dimensional article. In embodiments, various parameters characterizing the three-dimensional article may be selected for simulation and optimization. For example, the tensile strength, the electrical conductivity, the thermal conductivity, the density, the porosity, the specific surface area, or combinations of these, may be optimized with respect to the three-dimensional article.

However, as mentioned hereinabove, the three-dimensional article may have one or more design-optimized constraints. That is, the physical parameters of the three-dimensional article, such as the physical dimensions, may be necessarily limited due to the intended application of the three-dimensional article. Accordingly, in embodiments properties of the three-dimensional article, such as tensile strength, may not be capable of optimization via alteration of the physical parameters of the three-dimensional article, such as increasing the thickness of the walls of three-dimensional article. Put more simply, the structure of the three-dimensional article has already been optimized and, as a result, some other property must be augmented in order to further optimize the three-dimensional article.

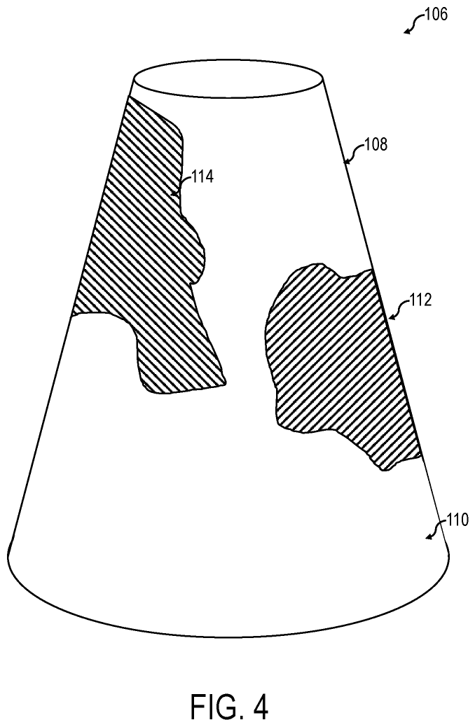

Accordingly, at block 310 the three-dimensional article may be optimized via the augmentation of the base materials that make up the three-dimensional article. For example, in order to increase the tensile strength of a three-dimensional article composed of a single base material, a second base material with a greater tensile strength than the first base material may be incorporated into the structure of the three-dimensional article. The second base material may be incorporated throughout the structure of the three-dimensional article to generally increase the tensile strength of the three-dimensional article, or selectively incorporated into portions of the structure of the three-dimensional article that may require increased tensile strength to improve a particular function. For example, referring now to FIG. 4, a three-dimensional article 106, which has been optimized via the augmentation of the base materials that make up the three-dimensional article, may comprise a first region 108 comprising a first base material 110 and a second region 112 comprising a second base material 114. In embodiments, for example, it may be desirable for the second region 112 to have a greater tensile strength than the first region 108. Accordingly, the second base material 114 may be selected such that it has a greater tensile strength than the first base material 110. While the three-dimensional articles may be described herein with respect to optimization via the incorporation of two base materials, it should be understood that embodiments may include the incorporation of more than two base materials. The resulting three-dimensional article may be structurally optimized to enhance performance by departing from the simple geometric designs that can be economically produced through conventional manufacturing techniques, such as casting and subtractive machining, while also being further optimized by the inclusion of more than single base material.

In embodiments, the three-dimensional article may be simulated and optimized via a computing device, such as the user computing device 102 or electronic controller 104. The electronic controller 104 may be operable to optimize the three-dimensional article based on at least one parameter characterizing the three-dimensional article and generate a three-dimensional model, such as a CAD file, corresponding to the optimized three-dimensional article. In embodiments, the electronic controller 104 may optimize the three-dimensional article manually, such as through user input, or through a semi- or fully-automated process that utilizes one or more databases comprising a selection of suitable base materials and their known properties. These known base materials may then be applied to the structure of the three-dimensional article to achieve a predetermined value for one or more parameters.

Still referring to FIG. 3, at block 320 a set of print instructions corresponding to the three-dimensional model is generated. In particular, a set of print instructions based on a conformation of the three-dimensional article and one or more deconstruction parameters may be derived from the three-dimensional article. In embodiments, the print instructions may be generated via a computing device, such as the user computing device 102 or electronic controller 104. In embodiments, the computing device may the same as the computing device utilized to optimize the three-dimensional article, or, alternatively, the computing device may be communicatively coupled to the computing device utilized to optimize the three-dimensional article. In embodiments, the electronic controller 104 may be operable to discretize the three-dimensional model generated during the optimization of the three-dimensional article, depicted in FIG. 3 as block 310. For example, the computing device may discretize the three-dimensional model into a plurality of segments or layers along a printing plane. The discretization may be based on a set of deconstruction parameters, user specified object properties, or combinations of these. As used herein, the term “deconstruction parameters” may refer to parameters defined by information, such as layer thickness, infill percentage, infill pattern, raster angle, build orientation, extrudate width, layer height, shell number, infill overlap, grid spacing, or combinations of these. For example, when generating print instructions for use in conjunction with fused deposition modeling, the user computing device may discretize the three-dimensional model via deconvolution into a single string. That is, the three-dimensional model may be unwound into a single continuous string that may then be reconstructed, such as by an additive manufacturing device, to produce a three-dimensional article with a structure and material compositions that corresponds to the three-dimensional model.

After discretization of the three-dimensional model, the computing device may generate a set of print instructions based on the plurality of segments or layers. The print instructions, also commonly referred to as tool path instructions, may be utilized by an additive manufacturing device when fabricating a three-dimensional article. For example, when the additive manufacturing device utilizes fused deposition modeling, the print instructions may direct a print head or an extruder of the additive manufacturing device to follow a particular tool path and deposit print materials or extrudate to fabricate a segment or layer corresponding to the discretization of the three-dimensional model. This process may be repeated until each segment or layer, as directed by the print instructions, has been fabricated in order to complete the three-dimensional article.

Still referring to FIG. 3, at block 330 an additive manufacturing feedstock is prepared. In particular, an additive manufacturing feedstock corresponding to the generated set of print instructions is prepared. That is, an additive manufacturing feedstock may be prepared such that it may be utilized or fed through an additive manufacturing device, in conjunction with the generated print instruction, in order to fabricate the optimized three-dimensional article. Accordingly, in embodiments wherein the three-dimensional article comprises two or more base materials, the additive manufacturing feedstock may be prepared such that it comprises the two or more base materials. As mentioned hereinabove, the three-dimensional article may be optimized via the augmentation of the base materials that make up the three-dimensional article. For example, in order to increase the tensile strength of a three-dimensional article, a base material with suitable tensile strength may be incorporated into the structure of the three-dimensional article. Similarly, in order to increase the electrical conductivity of the same three-dimensional article, another base material with suitable electrical conductivity may also be incorporated into the structure of the three-dimensional article. Accordingly, in embodiments, the at least one parameter of the first base material may be different from the at least one parameter of the second base material.

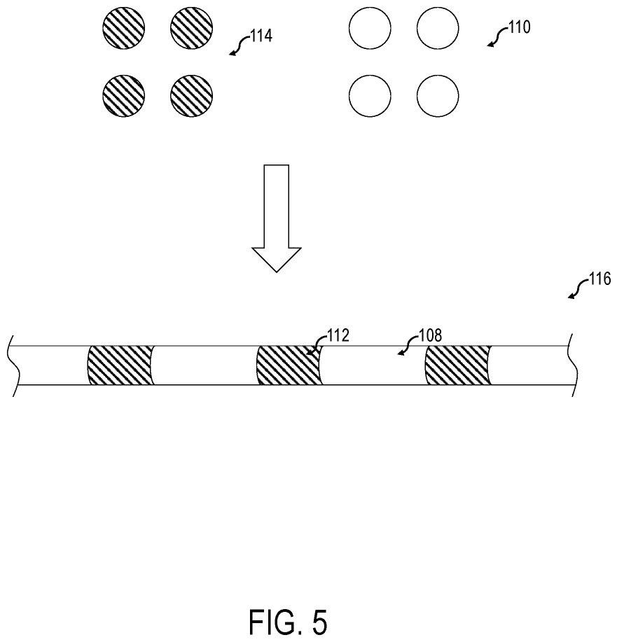

In embodiments, the additive manufacturing feedstock may be prepared in accordance with the desired means of additive manufacturing. For example, when the additive manufacturing device utilizes fused deposition modeling, the additive manufacturing feedstock may be prepared as a filament or feedstock spool. In particular, an additive manufacturing feedstock corresponding to the string produced via deconvolution of the three-dimensional model, as discussed previously, may be prepared such that the feedstock may be utilized by an additive manufacturing device, in conjunction with the print instruction, to produce a three-dimensional article with a structure and material compositions that corresponds to the three-dimensional model. Accordingly, a string of additive manufacturing feedstock may be prepared such that the additive manufacturing feedstock comprises at least a first portion comprising a first base material and a second portion comprising a second base material. For example, referring now to FIG. 5, an additive manufacturing feedstock 116 may be prepared using a first base material 110 and a second base material 114. The first base material 110 and the second base material 114 may be incorporated into the additive manufacturing feedstock 116 such that the additive manufacturing feedstock 116 comprises at least, for example, a first region 108 comprising the first base material 110, and a second region 112 comprising the second base material 114.

In embodiments, at least one parameter of the first base material may be different from at least one parameter of the second base material. For example, the tensile strength of the first base material may be greater than the tensile strength of the second base material. As another example, electrical conductivity of the first base material may be greater than the conductivity of the second base material. The spool may transition from the first base material to the second base material in a manner that corresponds to the generated print instructions. As a result, the second base material will be incorporated throughout the structure of the three-dimensional article during fabrication, or in particular portions of the structure of the three dimensional article, and improve or optimize a parameter of the three-dimensional article, such as tensile strength. For example, the first base material may have a higher tensile strength than the second base material and, as a result, portions of the three-dimensional article that comprise the first base material (as determined during simulation of the three-dimensional model and the generation of print instruction) will have a greater tensile strength than portions of the three-dimensional article that comprise the second base material. That is, the methods of the present disclosure may produce a three-dimensional article that is monolithic, but comprises various portions with differing physical parameters.

Referring again to FIG. 3, at block 340, the set of print instructions generated at block 320 and the additive manufacturing feedstock, such as the additive manufacturing feedstock 116 depicted in FIG. 5, prepared at block 330 may be supplied to an additive manufacturing device, such as the additive manufacturing device 105 depicted in FIGS. 1 and 2. As described hereinabove, the additive manufacturing device 105 may generally comprise any device capable of fabricating the three-dimensional article using the additive manufacturing feedstock based on the set of print instructions. For example, the additive manufacturing device may comprise any rapid-prototyping, rapid manufacturing device, or additive manufacturing device, such as fused deposition modeling (FDM), stereolithography (SLA), digital light processing (DLP), selective laser sintering (SLS), selective laser melting (SLM), laminated object manufacturing (LOM), or electron beam melting (EBM) devices. At block 350, the three-dimensional article may be fabricated. In particular, the additive manufacturing device 105 may fabricate the three-dimensional article 106 corresponding to the print instructions generated at block 320 utilizing the additive manufacturing feedstock prepared at block 330. That is, the additive manufacturing device 105 may fabricate the three-dimensional article 106 such that it is optimized relative to one or more design-optimized constraints by incorporating at least two base materials into the three-dimensional article during fabrication.

It should be understood that steps of the aforementioned process may be omitted or performed in a variety of orders while still achieving the object of the present disclosure. The functional blocks and/or flowchart elements described herein may be translated onto machine-readable instructions. As non-limiting examples, the machine-readable instructions may be written using any programming protocol, such as: descriptive text to be parsed (e.g., such as hypertext markup language, extensible markup language, etc.), (ii) assembly language, (iii) object code generated from source code by a compiler, (iv) source code written using syntax from any suitable programming language for execution by an interpreter, (v) source code for compilation and execution by a just-in-time compiler, etc. Alternatively, the machine-readable instructions may be written in a hardware description language (HDL), such as logic implemented via either a field programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

It should now be understood that the embodiments described herein are directed to additive manufacturing processes for the production of three-dimensional articles and, more specifically, the augmentation of the base materials of an additive manufacturing process relative to the design-optimized constraints of the three-dimensional article. The embodiments of the present disclosure may allow for further optimization of additive manufacturing processes and the resulting three-dimensional articles by augmenting the base materials such that the three-dimensional article is composed of two, three, four, or more base materials as opposed to just one. This may allow for the improvement or optimization of additional parameters, such as tensile strength, within the design-optimized constraints of the structure of the three-dimensional article and the intended application.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for additive manufacturing a three-dimensional article, the method comprising:
simulating the three-dimensional article based on at least one parameter characterizing the three-dimensional article such that the three-dimensional article comprises a first region comprising a first base material and a second region comprising a second base material;
generating a set of print instructions based on a conformation of the three-dimensional article;
preparing an additive manufacturing feedstock comprising the first base material and the second base material based on the three-dimensional article; and
supplying the set of print instructions and the additive manufacturing feedstock to an additive manufacturing device, whereby the additive manufacturing device fabricates the three-dimensional article using the additive manufacturing feedstock based on the set of print instructions.

2. The method of claim 1, further comprising:
deconvoluting the three-dimensional article into a string of the additive manufacturing feedstock comprising the first base material and the second base material; and
supplying the string of the additive manufacturing feedstock to the additive manufacturing device.

3. The method of claim 2, wherein the string of the additive manufacturing feedstock includes a first portion comprising the first base material and a second portion comprising the second base material.

4. The method of claim 1, wherein the at least one parameter of the first base material is different from the at least one parameter of the second based material.

5. The method of claim 1, wherein the at least one parameter characterizing the three-dimensional article is selected from one or more of tensile strength, electrical conductivity, thermal conductivity, density, porosity, and specific surface area.

6. The method of claim 1, wherein simulating the three-dimensional article comprises augmenting the first base material of the three-dimensional article relative to a design-optimized constraint of the three-dimensional article such that the three-dimensional article further comprises the second base material.

7. The method of claim 1, wherein simulating the three-dimensional article comprises generating a three-dimensional model corresponding to the three-dimensional article.

8. The method of claim 1, wherein generating the set of print instructions comprises discretizing a three-dimensional model corresponding to the three-dimensional article into a plurality of segments or layers along a printing plane.

9. The method of claim 8, wherein the discretizing is based on of the one or more deconstruction parameters.

10. The method of claim 9, wherein the one or more deconstruction parameters are defined by one or more of layer thickness, infill percentage, infill pattern, raster angle, build orientation, extrudate width, layer height, shell number, infill overlap, and grid spacing.

11. The method of claim 1, wherein the additive manufacturing device comprises one of fused deposition modeling, stereolithography, digital light processing, selective laser sintering, selective laser melting, laminated object manufacturing, or electron beam melting devices.

12. A system for additive manufacturing a three-dimensional article, the system comprising:
a controller configured to:
simulate the three-dimensional article based on at least one parameter characterizing the three-dimensional article such that the three-dimensional article comprises a first region comprising a first base material and a second region comprising a second base material;
generate a set of print instructions based on a conformation of the three-dimensional article; and
generate an additive manufacturing feedstock comprising the first base material and the second base material based on the three-dimensional article; and
an additive manufacturing device operable to fabricate the three-dimensional article using the additive manufacturing feedstock based on the set of print instruction.

13. The system of claim 12, wherein the controller is configured to:
deconvolute the three-dimensional article into a string of the additive manufacturing feedstock comprising the first base material and the second base material; and
supply the string of the additive manufacturing feedstock to the additive manufacturing device.

14. The system of claim 12, wherein the string of the additive manufacturing feedstock includes a first portion comprising the first base material and a second portion comprising the second base material.

15. The system of claim 12, wherein the at least one parameter of the first base material is different from the at least one parameter of the second based material.

16. The system of claim 12, wherein the at least one parameter characterizing the three-dimensional article is selected from one or more of tensile strength, electrical conductivity, thermal conductivity, density, porosity, and specific surface area.

17. The system of claim 12, wherein simulating the three-dimensional article comprises augmenting the first base material of the three-dimensional article relative to a design-optimized constraint of the three-dimensional article such that the three-dimensional article further comprises the second base material.

18. The system of claim 12, wherein simulating the three-dimensional article comprises generating a three-dimensional model corresponding to the three-dimensional article.

19. The system of claim 12, wherein generating the set of print instructions comprises discretizing a three-dimensional model corresponding to the three-dimensional article into a plurality of segments or layers along a printing plane.

20. The system of claim 12, wherein the discretizing is based on of the one or more deconstruction parameters.
